(19) United States
(12) Patent Application Publication
(10) Pub. No.: US 2016/0319868 A1
(43) Pub. Date: Nov. 3, 2016

(54) PLASTIC ROLLING BEARING CAGE FOR AN ANGULAR BALL BEARING, AND ANGULAR BALL BEARING

(71) Applicant: SCHAEFFLER TECHNOLOGIES AG & CO. KG, Herzogenaurach (DE)

(72) Inventors: Nico Kirchhoff, Schwebheim (DE); Sven Claus, Nurnberg (DE); Markus Scheidel, Hochstadt (DE); Jorg Loos, Herzogenaurach (DE); Sergej Mensch, Schwebheim (DE)

(73) Assignee: Schaeffler Technologies AG & Co. KG, Herzogenaurach (DE)

(21) Appl. No.: 15/105,374

(22) PCT Filed: Nov. 17, 2014
(86) PCT No.: PCT/DE2014/200637

§ 371 Date: Jun. 16, 2016

(30) Foreign Application Priority Data
Dec. 16, 2013 (DE) 10 2013 225 995.6

(51) Int. Cl. F16C 33/38; F16C 33/66; F16C 43/06; F16C 19/16

(52) U.S. Cl. CPC F16C 33/3856; F16C 19/163; F16C 33/6696; F16C 43/065; F16C 2202/52; F16C 2206/06; F16C 2208/36; F16C 2202/54; F16C 2240/70

(57) ABSTRACT

A plastic rolling bearing cage, namely an angular ball bearing cage, including two cage rings, the diameters of which differ from one another, namely a smaller cage ring and a larger cage ring. A number of cage pockets for accommodating in each case a rolling body, namely a ball, are formed by the cage rings and by the cage webs connecting them. The cage rings are designed in one piece with the cage webs and contain solid lubricant. The ratio of the third power of the width (BKi, BKa) of the cage ring, which is measured in the axial direction, and the cage pocket diameter (DW) is at least 0.4 mm².

### BACKGROUND

The invention relates to a plastic rolling bearing cage that is suitable for use in an angular ball bearing. Here the invention is a ball bearing cage that contains at least one solid lubricant.

A rolling bearing cage containing solid lubricant, namely a ball bearing cage, is known, for example, from EP 1 830 082 B1. This rolling bearing cage is produced from a resin compound that contains reinforcement fibers and 3 to 40 wt. % ball-shaped carbon. The ball-shaped carbon used as the solid lubricant can have an average particle diameter of 100 μm or less.

Another ball bearing cage with a solid lubricant is known from JP 2010-053971 A. In this ball bearing cage, substances that should reduce friction are distributed non-uniformly, wherein the maximum density of these substances is on the inner surfaces of cage pockets.

### SUMMARY

The invention is based on the objective of improving a rolling bearing cage, namely a ball bearing cage for an angular ball bearing, which is produced from a plastic containing solid lubricant, in particular, with respect to durability relative to the cited prior art, also under unfavorable environmental conditions.

This objective is achieved by a plastic rolling bearing cage with one or more features of the invention. The objective is further achieved by a rolling bearing having such a plastic rolling bearing cage.

The plastic rolling bearing cage constructed as an angular ball bearing cage has, in a known basic shape, two cage rings of different diameters that are spaced apart from each other in the axial direction and have a common axis of symmetry and a number of cage pockets that are each constructed for holding a rolling body and are defined by the cage rings and by cage webs integrally connecting these rings, wherein the cage rings and the cage webs contain solid lubricant.

The rolling body diameter, that is, the diameter of each ball of the rolling bearing having the plastic rolling bearing cage, namely the angular ball bearing, is somewhat smaller than the cage pocket diameter, so that the balls are guided in the cage pockets with minimal play.

According to the invention, the minimum width of each cage web measured in the circumferential direction of the cage is at least 15% of the cage pocket diameter and the ratio between the third power of the width specified in millimeters and measured in the axial direction of each cage ring and the rolling body diameter is at least 0.4 mm² and preferably at most 1.5 mm².

The specified quantitative relationships between the cage pocket diameter on one side and the web width and the width of the cage ring in the axial direction of the cage on the other side also apply in a preferred construction for the relationships between the rolling body diameter and the web width or the width of the cage ring. This means that for a rolling bearing having the cage according to the invention, preferably the minimum width of each cage web measured in the circumferential direction of the cage is at least 15% of the rolling body diameter and the relationship between the third power of the width of the cage ring measured in the axial direction and the rolling body diameter is at least 0.4 mm² and preferably at most 1.5 mm².

The plastic rolling bearing cage is suitable, in particular, for use in a minimally lubricated or only initially lubricated rolling bearing. Minimally lubricated rolling bearings are also understood to be rolling bearings that—apart from the lubricant contained in the rolling bearing cage—operate completely without lubrication, as well as media-lubricated rolling bearings. For media lubrication, instead of a lubricant, a substance whose primary function is not lubrication, is present in the bearing. Such a material can be, for example, a liquefied gas that is fed into a pump equipped with the rolling bearing. The medium, which acts on the rolling bearing, in particular, wets surfaces that are exposed to rolling loads, can be an acid or a base. For rolling bearings that are operated under water, in particular, in seawater, and whose components are exposed directly to the surrounding water due to insufficient or incomplete sealing, media-lubricated bearings are also mentioned.

As the plastic for producing the rolling bearing cage, in particular, polyether ether ketone (PEEK) is suitable. An especially suitable material is PEEK 10/10/10. Added to the polyether ether ketone base material is, for this material, which is also available on the market with the designation FC30, 10% PTFE (p olytetrafluoroethylene), graphite, and carbon fibers. In addition or as an alternative to the solid graphite lubricant, molybdenum disulfide (MoS₂) can also be included in the plastic of the rolling bearing cage. As a suitable cage material in addition to PEEK 10/10/10, in particular, PEEK 10/10/2 is to be noted. While graphite also provides good lubricating properties of the cage in the presence of air moisture, if there is no air moisture or in a vacuum, in particular, MoS₂ is suitable as the solid lubricant. As base materials from which the rolling bearing cage can be produced, in addition to PEEK, in particular, polyamide imide (PAI) and polyimide (PI) are to be noted. A common property of the mentioned materials is their suitability for operation at high temperatures. The continuous operation temperature, at which the plastic rolling bearing cage can be operated, is preferably greater than 150° C., in particular, greater than 200° C. Also when the specified temperature limits are reached, the strength of the plastic rolling bearing cage is only slightly reduced.

Other materials that contain PEEK and are suitable for producing the rolling bearing cage are described, for example, in the following dissertation:

Géraldine Theiler: PTFE- and PEEK-Matrix Composites for Tribological Applications at Cryogenic Temperatures and in Hydrogen; School III—Processing Sciences of TU Berlin; Berlin 2005.

Around the circumference of the cage ring there are, according to one advantageous refinement, multiple material projections that are directed radially outward and can run on the outer ring of the rolling bearing. Here, a contact between the cage and the outer ring can be given either permanently or only under certain operating conditions. In the latter case, for example, strong vibrations of the bearing represent such operating conditions. The contact of the material projections of the cage on the outer ring has, in this case, a damping effect. Simultaneously, this increases the transfer of solid lubricant onto the outer ring and from there, in turn, onto the rolling bodies.

According to one possible construction, the number of material projections located on the circumference of the rolling bearing cage is less than the number of cage pockets. Likewise, constructions can be realized in which on each web of the rolling bearing cage or in the transition region between each web and a cage ring there is a material projection. In each case, the number of cage pockets is preferably even, which provides manufacturing-relates advantages, especially for the production of the rolling bearing cage in the injection molding process.

The cage ring of the rolling bearing cage formed as an angular ball bearing cage having the larger diameter does not necessarily have the same width, in the axial direction of the rolling bearing cage, as the smaller cage ring. For example, the cage ring with the smaller diameter could be narrower than the larger cage ring in the axial direction. In each case, the cage pockets of the angular ball bearing cage formed between the cage rings and the webs connecting these rings are advantageously constructed such that the balls can be snapped into these pockets.

The radially outer cage ring of the angular ball bearing cage is connected to the radially inner cage ring, in the preferred construction by webs running essentially in the axial direction, wherein the webs have a radially outer contour that describes a straight-line extension of the ring-shaped outer contour of the outer cage ring, so that radially outer contours of all webs and the outer circumference of the outer cage ring are on the same cylindrical surface.

Accordingly, in this construction the cylindrical inner contour of the smaller cage ring in the axial direction of the rolling bearing, running in the direction toward the larger cage ring, transitions into radially inner contours of the webs that lie on the same imaginary cylindrical surface as the inner circumference of the inner, smaller cage ring. In an especially preferred construction, an area lying axially between the two end sides of the rolling bearing cage and thus between the two cage rings, in which the outer contour of the webs has the same diameter as the outer contour of the larger cage ring and the inner contour of the webs has the same diameter as the inner contour of the smaller cage ring. This transition area in which each web extends in the radial direction from the inner diameter of the inner cage ring up to the outer diameter of the outer cage ring preferably has, in the axial direction, an extent that corresponds to at least 10%, in particular, at least 20%, of the distance between the two end sides of the angular ball bearing cage, wherein the wall thickness of the cage measured in the radial direction decreases from this transition area to the end sides.

The plastic rolling bearing cage according to the invention can be used in single-row ball bearings and also in multiple-row ball bearings.

### BRIEF DESCRIPTION OF THE DRAWINGS

Multiple embodiments of the invention are explained below in more detail with reference to a drawing. Shown herein are:

FIG. 1 a plastic rolling bearing cage constructed as an angular ball bearing cage in a perspective view,

FIG. 2 a detail of the rolling bearing cage according to FIG. 1 in a section view,

FIG. 3 a second embodiment of a plastic rolling bearing cage constructed as an angular ball bearing cage in a perspective view, and

FIG. 4 a detail of the rolling bearing cage according to FIG. 3 in a section view analogous to FIG. 2.

### DETAILED DESCRIPTION OF THE PREFERRED EMBODIMENTS

Parts that correspond to each other or that have identical functions are marked in all of the figures with identical reference symbols.

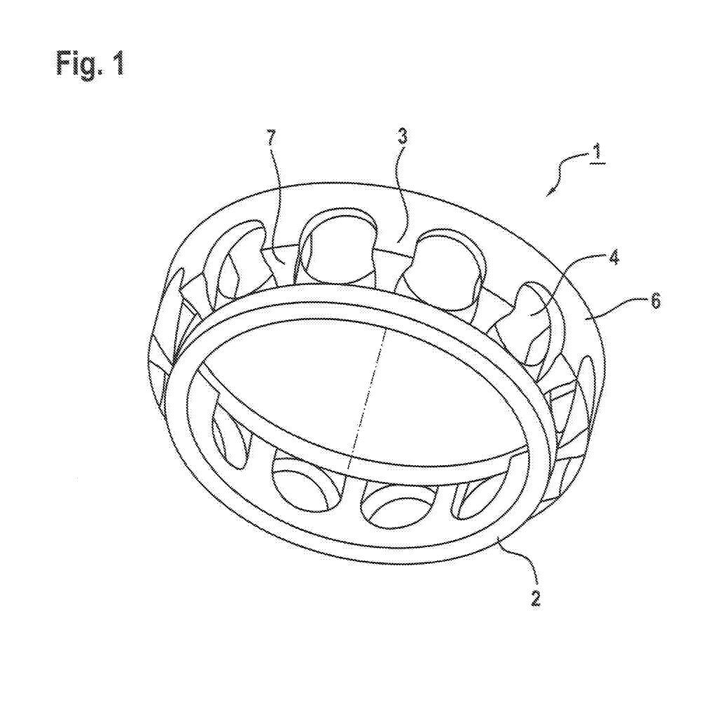

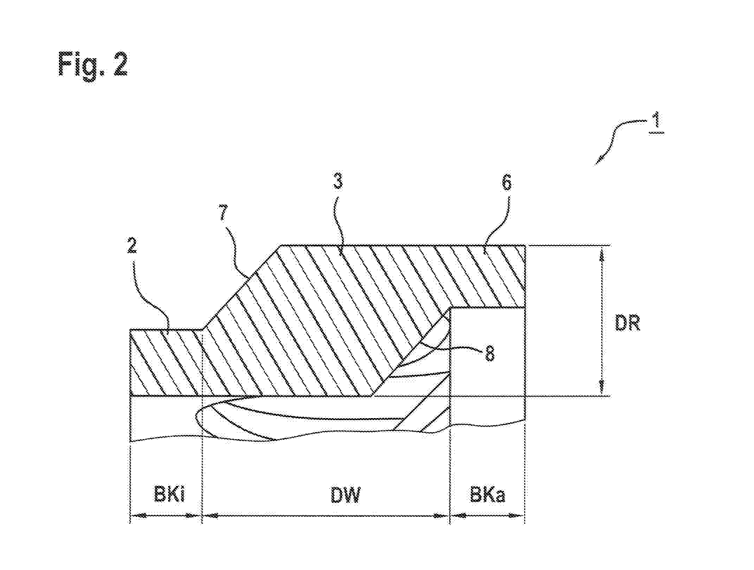

A plastic rolling bearing cage 1, namely a ball bearing cage, shown in FIGS. 1 and 2, is constructed as a cage for an angular ball bearing that is not shown in more detail.

The rolling bearing cage 1 has two cage rings 2, 6 with different dimensions, namely a smaller cage ring 2 and a larger cage ring 6. The cage webs 3 connecting the cage rings 2, 6 run essentially in the axial, partially also in the radial direction of the rolling bearing cage 1, wherein an outer contour of the cage webs 3 connects flush to the outer contour of the larger cage ring 6 and an inner contour of the cage webs 3 connects flush to an inner contour of the smaller cage ring 2. The outer contour of the cage web 3 is connected by means of an outer cage flank 7 to the outer circumference of the smaller cage ring 2. The radially inner contour of the cage web 3 is connected by an inner cage flank 8 to the inner circumference of the larger cage ring 6. The cage flanks 7, 8 are parallel to each other and oriented at an angle to the axis of symmetry of the rolling bearing cage 1.

By the cage rings 2, 6 and the cage webs 3 integrally connecting these rings, cage pockets 4 are formed in each of which a rolling body, namely a ball, can be snapped. The rolling bodies can be made from steel, for example, from rolling bearing steel 100Cr6, or from a corrosion-resistant steel, or from a ceramic material, for example, silicon nitride.

The rolling bearing cage 1 is produced in an injection molding process and also has, in addition to the plastic used as the base material, a solid lubricant, namely graphite and/or MoS₂, that can be transferred in the course of the transfer lubrication from surfaces of the rolling bearing cage 1, in particular, from the cage pockets 4, via the rolling bodies to the not-shown raceways of the rolling bearing. In comparison to conventional ball bearing cages for angular ball bearings, the rolling bearing cage 1 according to FIG. 1 is formed with significantly thicker walls and provides a considerable wear volume that contributes to continuous relubrication of the rolling bearing during operation, wherein simultaneously the function of the rolling bearing cage 1 subject to wear in the provided way is maintained for a long term. The rolling bearing cage 1 is particularly suitable for dry-running and minimally or initially lubricated rolling bearings. The long-term temperature at which the rolling bearing equipped with the plastic rolling bearing cage 1 can be operated is at least 150° C. The rolling bearing is suitable, for example, for use in the food industry or in pharmaceutical production systems.

Each cage web 3 has an average width measured in the circumferential direction that corresponds to at least 15% of the diameter of the balls guided in the cage pockets 4. The diameter of the balls used as rolling bodies, apart from a cage pocket play of the rolling bodies in the cage pockets 4, is identical to the cage pocket diameter designated with DW, that is, the inner diameter of the spherical cage pockets 4. In the unused condition of the rolling bearing cage 1, the rolling bodies are guided with very low play in the cage pockets 4.

Each cage ring 2, 6 has centrally in the circumferential direction between two cage webs 3 the smallest width measured in the axial direction of the rolling bearing cage 1 and thus of the rolling bearing, wherein the minimum axial width of the smaller cage ring is designated with BKi and the minimum axial width of the larger cage ring is designated with BKa. Between the minimum cage ring width BKi, BKa and the cage pocket diameter DW, the following relationships apply:

0.4 mm²<BKi³/DW<1.5 mm² ; 0.4 mm²<BKa³/DW<1.5 mm²

The cage pockets 4 with the uniform diameter DW are constructed such that the cage webs 3 and the cage rings 2, 6 are at most minimally deformed when the rolling bodies are inserted into the cage pockets 4. Thus, also less elastic, brittle materials for producing the rolling bearing cage 1 could be used. Solid lubricants contained in the rolling bearing cage 1 could be distributed uniformly or non-uniformly within its volume or on its surface.

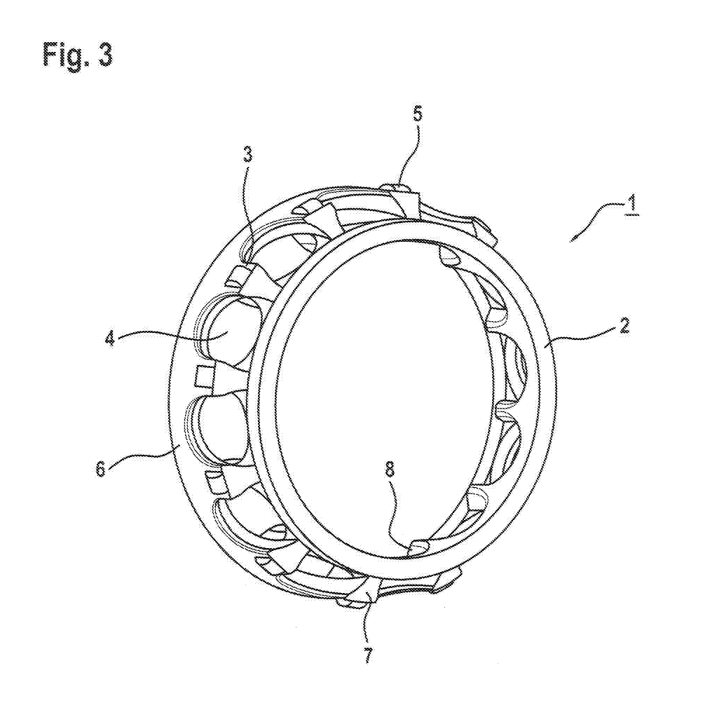

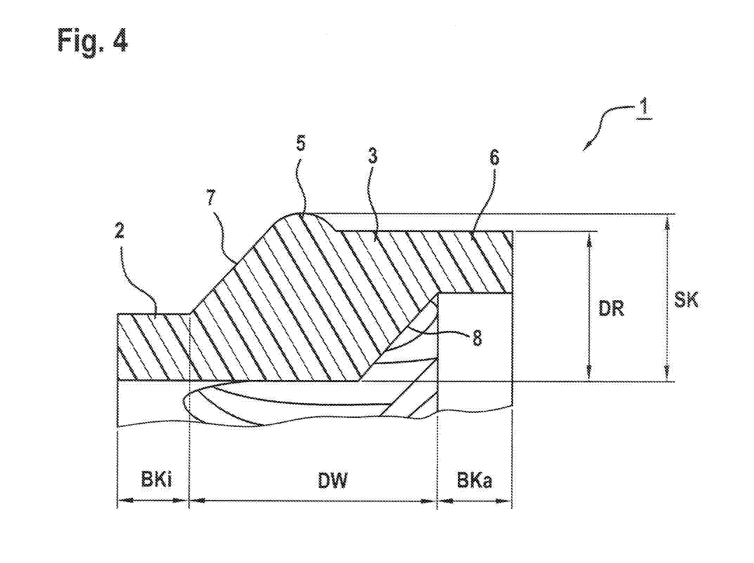

The embodiment according to FIGS. 3 and 4 differs from the embodiment according to FIGS. 1 and 2 in that the rolling bearing cage 1 has, on each cage web 3, an oblong material projection 5 rounded in the section according to FIG. 4 and directed radially outward, in the radial top view, onto the essentially cylindrical outer circumference of the rolling bearing cage 1. Starting from the radially outer contour of the larger cage ring 6 that extends into the cage web 3, the material projection 5 projects outward, describing a circular arc. Toward the smaller cage ring 2, the thickness of the cage web 3 measured in the radial direction of the rolling bearing cage 1 decreases continuously from the material projection 5 in the area of the outer cage flank 7 until the cage web 3 transitions into the smaller cage ring 2. The maximum thickness of the cage web 3 measured in the radial direction of the rolling bearing cage 1 and designated with SK, including the material projection 5, is greater than the distance also measured in the radial direction and designated with DR between the outer circumference of the larger cage ring 6 and the inner circumference of the smaller cage ring 2.

The material projections 5 can contact the outer ring especially in the case of vibrations of the angular ball bearing with the rolling bearing cage 1. In this way, on one hand, the vibrations are damped and, on the other hand, solid lubricant is transferred onto the raceway of the outer ring. In the course of the operation of the rolling bearing, the material projections 5 are subject to regular wear. Due to the spherical shape of the cage pockets 4, the rolling bodies are guided in the rolling bearing cage 1, also in the radial direction, even for partial or complete wear of the material projections 5.

### LIST OF REFERENCE NUMBERS

1 Plastic rolling bearing cage

2 Cage ring, smaller

3 Cage web

4 Cage pocket

5 Material projection

6 Cage ring, larger

7 Outer cage flank

8 Inner cage flank

BKi Minimum width of the smaller cage ring

BKa Minimum width of the larger cage ring

DR Radial distance between the outer diameter of the larger cage ring and the inner diameter of the smaller cage ring

DW Cage pocket diameter

SK Maximum extent of the cage web in the radial direction

1. A plastic rolling bearing cage, comprising two cage rings, whose diameters differ from each other to define a smaller cage ring and a larger cage ring, cage webs connecting said cage rings, a number of cage pockets that are limited by the cage rings and by the cage webs connecting said rings, each constructed for holding a rolling body and having a cage pocket diameter, the cage rings are constructed integrally with the cage webs and contain a solid lubricant, and a ratio between a third power of a width (BKi, BKa) of each of the cage rings measured in an axial direction and the cage pocket diameter (DW) is at least 0.4 mm².

2. A rolling bearing cage according to claim 1, wherein the cage webs extend in a radial direction from an inner diameter of the smaller cage ring up to an outer diameter of the larger cage ring.

3. The rolling bearing cage according to claim 2, further comprising several radially outward directed material projections located on an outer circumference.

4. The rolling bearing cage according to claim 3, wherein the material projections are located on the cage webs.

5. The rolling bearing cage according to claim 4, wherein a maximum thickness (SK) of the cage web measured in a radial direction of the rolling bearing cage, including the material projection, is greater than a distance (DR) also measured in the radial direction between an outer circumference of the larger cage ring and an inner circumference of the smaller cage ring.

6. The rolling bearing cage according to claim 1, further comprising polyether ether ketone as a base material.

7. The rolling bearing cage according to claim 1, further comprising graphite as the solid lubricant.

8. The rolling bearing cage according to claim 1, further comprising a fiber-reinforcement.

9. A rolling bearing comprising a number of rolling bodies, as well as a plastic rolling bearing cage according to claim 1.

10. A method of forming a low-lubricant rolling bearing, comprising:
providing a rolling bearing cage according to claim 1; and
assembling the rolling bearing cage with rolling elements between two bearing races to form a low-lubricant rolling bearing.
